(19) United States
(12) Patent Application Publication
(10) Pub. No.: US 2026/0050790 A1
(43) Pub. Date: Feb. 19, 2026

(54) NO GRADIENT ADAPTION OF TRANSFORMER-BASED LANGUAGE MODELS

(71) Applicant: GDM Holding LLC, Mountain View, CA (US)

(72) Inventor: Quan Wang, Hoboken, NJ (US)

(73) Assignee: GDM Holding LLC, Mountain View, CA (US)

(21) Appl. No.: 19/290,271

(22) Filed: Aug. 4, 2025

Related U.S. Application Data
(60) Provisional application No. 63/683,132, filed on Aug. 14, 2024.

(51) Int. Cl. G06N 3/091; G06N 3/045

(52) U.S. Cl. CPC G06N 3/091; G06N 3/045

(57) ABSTRACT

During a first prompt session, a method includes receiving a first prompt specifying a task for a language model (LM). For each biased attention layer of the LM, the method also includes: computing, based on the first prompt, a set of attention weights; and computing bias parameters for biasing a subsequent computation of the set of attention weights during a second prompt session. During the second prompt session, the method also includes receiving a second prompt specifying another task for the LM. For each biased attention layer, the method also includes: computing, based on the second prompt, the set of attention weights; and biasing, using the bias parameters computed during the first prompt session, the set of attention weights. The method also includes generating a corresponding response based on the biased sets of attention weights.

### CROSS-REFERENCE TO RELATED APPLICATIONS

This U.S. Patent Application claims priority under 35 U.S.C. § 119(e) to U.S. Provisional Application 63/683, 132, filed on Aug. 14, 2024. The disclosure of this prior application is considered part of the disclosure of this application and is hereby incorporated by reference in its entirety.

### TECHNICAL FIELD

This disclosure relates to no-gradient adaptation of transformer-based language models.

### BACKGROUND

Language models (LMs) are increasingly being trained and used to perform language-based tasks, such as speech recognition or transcription, or text recognition, summarization, translation, prediction, understanding, processing, or generation.

### SUMMARY

One aspect of the disclosure provides a computer-implemented method that when executed on data processing hardware causes the data processing hardware to perform operations that include, during a first prompt session between a user and a language model (LM): receiving a first prompt from the user that specifies a task for the LM to perform, and for each corresponding biased attention layer of a plurality of biased attention layers of the LM: computing, based on the first prompt, a corresponding set of attention weights for the corresponding biased attention layer; computing, based on the corresponding set of attention weights, bias parameters for biasing a subsequent computation of the corresponding set of attention weights during a second prompt session; and storing the computed bias parameters in memory cache in communication with the data processing hardware. The operations also include, during the first prompt session, generating a corresponding response to the first prompt based on the sets of attention weights computed for the plurality of biased attention layers. During the second prompt session between the user and the LM, the operations also include: receiving a second prompt from the user that specifies another task for the LM to perform, and for each corresponding biased attention layer of the plurality of biased attention layers: computing, based on the second prompt, the corresponding set of attention weights for the corresponding biased attention layer; and biasing, using the bias parameters stored in the memory cache that were computing for the corresponding biased attention layer during the first prompt session, the corresponding set of attention weights. During the second prompt session, the operations also include generating a corresponding response to the second prompt based on the biased sets of attention weights computed for the plurality of biased attention layers.

Implementations of the disclosure may include one or more of the following optional features. In some implementations, the operations further include, after generating the corresponding response to the second prompt during the second prompt session: receiving binary feedback indicating one of positive feedback or negative feedback from the user, the positive feedback indicating the user is satisfied with the corresponding response to the second prompt and the negative feedback indicating the user is dissatisfied with the corresponding response to the second prompt; and for at least one corresponding biased attention layer of the plurality of biased attention layers, updating, using the corresponding set of attention weights computed for the at least one corresponding biased attention layer during the second prompt session conditioned upon the corresponding response to the second prompt and the binary feedback, the bias parameters stored in the memory cache for biasing a subsequent computation of the corresponding set of attention weights during a third prompt session. Here, the bias parameters stored in the memory cache for biasing the subsequent computation of the corresponding set of attention weights during the third prompt session may be computed without computing any gradients. In these implementations, updating the bias parameters stored in the memory cache using the corresponding set of attention weights computed for the at least one corresponding biased attention layers during the second prompt session may be conditioned upon the corresponding response to the second prompt, and the binary feedback may be further based on a scaling factor.

In some examples, the operations further include, after generating the corresponding response to the second prompt during the second prompt session, for at least one corresponding biased attention layer of the plurality biased attention layers, updating, using the corresponding set of attention weights computed for the at least one corresponding biased attention layer during the second prompt session, the bias parameters stored in the memory cache for biasing a subsequent computation of the corresponding set of attention weights during a third prompt session In these examples, updating the bias parameters stored in the memory cache using the corresponding set of attention weights computed for the at least one corresponding biased attention layer during the second prompt session may be further based on a scaling factor.

In some implementations, the operations further include, during the first prompt session, for each corresponding biased attention layer: determining that previous bias parameters for the corresponding biased attention layer are stored in the memory cache, the previous bias parameters computed for the corresponding biased attention layer during a prior prompt session that precedes the first prompt session; and determining a largest number in the set of attention weights computed for the corresponding biased attention layer. In these implementations, computing the bias parameters for the corresponding biased attention layer during the first prompt session includes: when the largest number in the set of attention weights satisfies a predefined threshold number, updating, using the corresponding set of attention weights, the bias parameters stored in the memory cache for biasing the subsequent computation of the corresponding set of attention weights during the second prompt session; or when the largest number in the set of attention weights dissatisfies the predefined threshold number, using the previous bias parameters stored in the memory cache for biasing the subsequent computation of the corresponding set of attention weights during the second prompt session.

In some examples, the set of bias parameters used to bias the corresponding set of attention weights during the second prompt session represent an exponential decaying moving average of the set of attention weights previously computed for the corresponding biased attention layer during the first prompt session. In some additional examples, the set of bias parameters used to bias the corresponding set of attention weights during the second prompt session bias the corresponding set of attention weights are computed without computing a gradient.

Optionally, the corresponding response to the second prompt may be generated during the second prompt session without integrating, as conversational history into the second prompt, the first prompt and the corresponding response to the first prompt generated during the first prompt session. Additionally or alternatively, the bias parameters stored in the memory cache for biasing the subsequent computation of the corresponding set of attention weights during the second prompt session may be specific to the same user from whom the first prompt and the second prompt were received from. For instance, multiple sets of bias parameters are stored in the memory cache, wherein each set of bias parameters may be specific to a different respective user.

In some implementations, the LM includes a pre-trained neural network-based LM that optimizes parameters of the neural network-based LM during training. Here, the parameters of the neural network-based LM are frozen during the first and second prompt sessions during inference. In these implementations, the task specified by the first prompt and the other task specified by the second prompt are associated with a capability that the pre-trained neural network-based LM is not trained to perform.

Another aspect of the disclosure provides a system that includes data processing hardware and memory hardware storing instructions that when executed on the data processing hardware causes the data processing hardware to perform operations that include, during a first prompt session between a user and a language model (LM): receiving a first prompt from the user that specifies a task for the LM to perform, and for each corresponding biased attention layer of a plurality of biased attention layers of the LM: computing, based on the first prompt, a corresponding set of attention weights for the corresponding biased attention layer; computing, based on the corresponding set of attention weights, bias parameters for biasing a subsequent computation of the corresponding set of attention weights during a second prompt session; and storing the computed bias parameters in memory cache in communication with the data processing hardware The operations also include, during the first prompt session, generating a corresponding response to the first prompt based on the sets of attention weights computed for the plurality of biased attention layers. During the second prompt session between the user and the LM, the operations also include: receiving a second prompt from the user that specifies another task for the LM to perform, and for each corresponding biased attention layer of the plurality of biased attention layers: computing, based on the second prompt, the corresponding set of attention weights for the corresponding biased attention layer; and biasing, using the bias parameters stored in the memory cache that were computing for the corresponding biased attention layer during the first prompt session, the corresponding set of attention weights. During the second prompt session, the operations also include generating a corresponding response to the second prompt based on the biased sets of attention weights computed for the plurality of biased attention layers.

This aspect of the disclosure may include one or more of the following optional features. In some implementations, the the operations further include, after generating the corresponding response to the second prompt during the second prompt session: receiving binary feedback indicating one of positive feedback or negative feedback from the user, the positive feedback indicating the user is satisfied with the corresponding response to the second prompt and the negative feedback indicating the user is dissatisfied with the corresponding response to the second prompt; and for at least one corresponding biased attention layer of the plurality of biased attention layers, updating, using the corresponding set of attention weights computed for the at least one corresponding biased attention layer during the second prompt session conditioned upon the corresponding response to the second prompt and the binary feedback, the bias parameters stored in the memory cache for biasing a subsequent computation of the corresponding set of attention weights during a third prompt session. Here, the bias parameters stored in the memory cache for biasing the subsequent computation of the corresponding set of attention weights during the third prompt session may be computed without computing any gradients. In these implementations, updating the bias parameters stored in the memory cache using the corresponding set of attention weights computed for the at least one corresponding biased attention layers during the second prompt session may be conditioned upon the corresponding response to the second prompt, and the binary feedback may be further based on a scaling factor.

In some examples, the operations further include, after generating the corresponding response to the second prompt during the second prompt session, for at least one corresponding biased attention layer of the plurality biased attention layers, updating, using the corresponding set of attention weights computed for the at least one corresponding biased attention layer during the second prompt session, the bias parameters stored in the memory cache for biasing a subsequent computation of the corresponding set of attention weights during a third prompt session. In these examples, updating the bias parameters stored in the memory cache using the corresponding set of attention weights computed for the at least one corresponding biased attention layer during the second prompt session may be further based on a scaling factor.

In some implementations, the operations further include, during the first prompt session, for each corresponding biased attention layer: determining that previous bias parameters for the corresponding biased attention layer are stored in the memory cache, the previous bias parameters computed for the corresponding biased attention layer during a prior prompt session that precedes the first prompt session; and determining a largest number in the set of attention weights computed for the corresponding biased attention layer. In these implementations, computing the bias parameters for the corresponding biased attention layer during the first prompt session includes: when the largest number in the set of attention weights satisfies a predefined threshold number, updating, using the corresponding set of attention weights, the bias parameters stored in the memory cache for biasing the subsequent computation of the corresponding set of attention weights during the second prompt session; or when the largest number in the set of attention weights dissatisfies the predefined threshold number, using the previous bias parameters stored in the memory cache for biasing the subsequent computation of the corresponding set of attention weights during the second prompt session.

In some examples, the set of bias parameters used to bias the corresponding set of attention weights during the second prompt session represent an exponential decaying moving average of the set of attention weights previously computed for the corresponding biased attention layer during the first prompt session. In some additional examples, the set of bias parameters used to bias the corresponding set of attention weights during the second prompt session bias the corresponding set of attention weights are computed without computing a gradient.

Optionally, the corresponding response to the second prompt may be generated during the second prompt session without integrating, as conversational history into the second prompt, the first prompt and the corresponding response to the first prompt generated during the first prompt session. Additionally or alternatively, the bias parameters stored in the memory cache for biasing the subsequent computation of the corresponding set of attention weights during the second prompt session may be specific to the same user from whom the first prompt and the second prompt were received from. For instance, multiple sets of bias parameters are stored in the memory cache, wherein each set of bias parameters may be specific to a different respective user.

In some implementations, the LM includes a pre-trained neural network-based LM that optimizes parameters of the neural network-based LM during training. Here, the parameters of the neural network-based LM are frozen during the first and second prompt sessions during inference. In these implementations, the task specified by the first prompt and the other task specified by the second prompt are associated with a capability that the pre-trained neural network-based LM is not trained to perform.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system using a language model (LM) for performing tasks.

FIG. 2 is a schematic view of an example biased attention layer.

FIG. 3 is a flow chart of an example arrangement of operations for a method of biasing an attention layer.

FIG. 4 is a schematic view of an example computing device that may be used to implement the systems and methods described herein.

Like reference symbols in the various drawings indicate like elements.

### DETAILED DESCRIPTION

Language models (LMs) are increasingly being trained and used to perform language-based tasks, such as speech recognition, speech translation, text recognition, text summarization, text translation, text prediction, text understanding, natural language processing, and text generation to name a few. Once an LM is trained and, in some examples, finetuned, the trained LM is then deployed to a production environment for inference (e.g., generating a text response when given a text prompt). During inference, the parameters of the trained LM are frozen. Traditionally, to improve the LM, the LM can be retrained/fine-tuned and then redeployed to a production environment. However, retraining of an LM is very expensive and, thus, cannot be performed on a frequent basis. In particular, the continuous training and deployment of updated LM models to production may require substantial time and engineering effort. One conventional method to train an LM during inference is to rerun a masked-token prediction pre-training task for each prompt upon completion of inference for the prompt. However, this requires computing a gradient and performing gradient descent, which is typically cost-prohibitive to perform in a production environment. Therefore, there is a need for improved methods of training LMs

Implementations herein are directed toward continuously training LMs (e.g., re-trained, updated, refined, etc.) during inference using a “learning by using” approach, without the need to compute any gradients or perform gradient descent and, thus, are substantially faster and less expensive than traditional methods of training an LM during inference. In particular, for one or more biased attention layers of an LM, implementations disclosed herein incorporate bias parameters for biasing attention weights computed by the biased attention layers. Here, the bias parameters may be locally adjusted during inference, with low complexity, and without having to adjust previously trained weights of the LM. In some examples, the bias parameters are adjusted based on feedback from a user based on results output from the LM during inference.

Training LMs, including large language models (LLMs) having billions of parameters, is a technical problem that specifically arises in the realm of computer systems Thus, an ability to continuously train (e.g., re-train, update, refine, fine-tune, etc.) an LM during inference in a production environment with low complexity represents a significant improvement to a computing environment's ability to train an LM and, therefore, represents a clear technical improvement to the technical field of training LMs in production environments. Specifically, by omitting the computation of any gradients or otherwise omitting the need to perform gradient descent for training, the ability to continuously train an LM during inference in a production environment is improved and, in fact, made technically possible since the high costs associated with gradient descent training techniques are no longer incurred. Moreover, by being able to continuously train an LM during inference in a production environment, the LM itself is also improved to perform better during inference than pre-trained LMs and, therefore, also represents a technical improvement for improving performance and accuracy of the LM. Furthermore, various examples disclosed herein include novel and particular techniques for continuously training LMs during inference and, thus, do not merely represent desired results or functions.

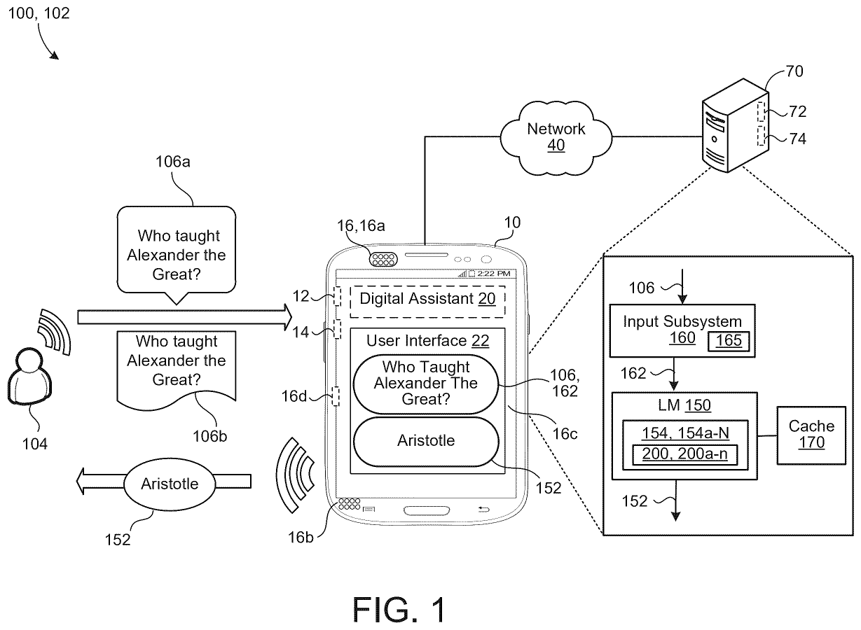

FIG. 1 is a schematic view of an example system 100 that includes an LM 150 (e.g., a large language model (LLM)) for performing tasks (e g., language-based tasks) within an environment 102. The system 100 includes a user device 10 interacting with a user 104 to perform tasks using the LM 150. In some examples, a digital assistant interface 20 (or simply ‘digital assistant’) executes on the user device 10 and the user 104 interacts with the digital assistant 20 by providing user inputs 106 that specify tasks for the LM 150 to perform. The user 104 may provide user inputs 106 in the form of speech-based user inputs 106a (e.g., spoken utterances) that includes audio data characterizing an utterance spoken by the user and/or text-based user inputs 106b via a physical or virtual keyboard 16d of the user device 10. The task specified by the user input 106 for the LM 150 to perform may include, without limitation, a query for the LM 150 to answer a question (i.e., a text generation task), a request for the LM to summarize text or contents of a document, a request to translate content written/spoken in one language into one or more other languages (i.e., a text generation task), a request to analyze sentiment/understanding of text (i.e., a text prediction task), facilitate conversation (e.g.

via the digital assistant) with the user 104, or generate continuation text that completes a sentence to name a few (i.e., a text generation task). In some examples, the LM 150 is leveraged as a speech decoder for outputting a speech recognition result of the spoken utterance 106a. In these examples, the LM 150 may decode audio encodings of the spoken utterance 106a encoded by an audio encoder of a speech recognition system 165 or the LM 150 may be leveraged as a second pass rescorer to rescore first pass speech recognition results for the utterances 106a that were output by the speech recognition system 165.

Accordingly, the LM 150 may be configured to perform speech recognition as a task or as a sub-task. For instance, the spoken input 106a may include the user speaking a question for the LM 150 to answer, whereby the LM 150 may initially output a transcription for the spoken utterance that conveys the question in text, and then process the text as a task prompt 162 to generate the response 152 that answers the question specified by the spoken user input 106a. In this sense, the user 104 may have a conversational dialog with the digital assistant 20 via back-and-forth interactions between the user 104 and the digital assistant 20 conveying responses 152 returned from the LM 150 to the user 104. Responses 152 (i.e., outputs) generated by the LM 150 and returned to the user 104 may indicate performance of tasks specified by corresponding user inputs 106. The digital assistant 20 may provide the response 152 as text for presentation in a user interface 22 displayed on a screen 16c of the user device 10 and/or as synthesized speech audibly output by an audio output device (e.g., speaker) 16b of the user device 10. In some examples, the response 152 generated by the LM 150 is represented by a sequence of text and a text-to-speech (TTS) system (not shown) converts the text into synthesized speech that conveys the response 152. In the example shown, the user 104 provides the user input 106 requesting the LM 150 to answer the question “Who taught Alexander the Great?” and the LM 150 answering the question by returning the response 150 of “Aristotle”.

The user device 10 may correspond to any computing device associated with a user 104 and capable of capturing user inputs 106 and providing, in response, textual or audible outputs. Some examples of user devices 10 include, but are not limited to, mobile devices (e.g., mobile phones, tablets, laptops, etc.), computers, wearable devices (e.g., a smart watch, smart glasses, smart goggles, an augmented reality (AR) headset, a virtual reality (VR) headset, etc.), smart appliances, Internet of things (IoT) devices, vehicle infotainment systems, smart displays, smart speakers, etc. The user device 10 includes data processing hardware 12 and memory hardware 14 in communication with the data processing hardware 12 and storing instructions that, when executed by the data processing hardware 12, causes the data processing hardware 12 to perform one or more operations. The user device 10 further includes, or is in communication with, one or more input/output devices 16, 16a-d, such as an audio capture device 16a (e.g., an array of one or more microphones) for capturing and converting spoken user inputs 106a into electrical signals, the audio output device 16b (e.g., a speaker), the screen 16c for presenting visual content, or the keyboard 16d (e.g., a physical or virtual keyboard) for capturing text-based user inputs 106b. Of course, any number and/or type(s) of other input/output devices 16 may be used. The input/output devices 16 may reside on or be in communication with the user device 10. The graphical user interface 22 may execute on the data processing hardware 12 for display on the screen 16d.

The system 100 includes an input subsystem 160 configured to receive the user input 106 and output a task prompt 162 representative of the user input 106. Here, the task prompt 162 specifies a task (e.g., a language-based task) for the LM 150 to perform responsive to the user input 106. For a text-based user input 106b, the task prompt 162 may simply include the sequence of words conveyed by the text-based user input 106b such that the text-based user input 106b is provided directly to the LM 150. However, for a speech-based user input 106a captured by the audio capture device 16a, the input subsystem 160 converts the audio data characterizing the spoken utterance 106a into a digital format for conversion into a speech recognition representation of the spoken utterance 106 by a speech recognition system 165. Here, the task prompt 162 includes the speech recognition representation of the spoken utterance 106a. In some examples, the speech recognition representation output by the speech recognition system 165 includes a transcription of the spoken utterance. Additionally or alternatively, the speech recognition representation may include an audio encoding of the audio data characterizing the utterance 106a output by an audio encoder of the speech recognition system 165 and/or a list of speech recognition hypotheses (e.g., a ranked list of candidate transcriptions) for the utterance 106a output by the speech recognition system 165. Any combination of the LM 150 and the speech recognition system 165 may

execute on the user device 10 and/or on a remote computing system 70 (e.g., one or more remote servers of a distributed system executing in a cloud-computing environment) in communication with the user device 10 via a network 40. The remote computing system 70 includes data processing hardware 72 and memory hardware 74 in communication with the data processing hardware 72. The memory hardware 74 stores instructions that, when executed by the data processing hardware 72, cause the data processing hardware 72 to perform one or more operations, such as operations disclosed herein.

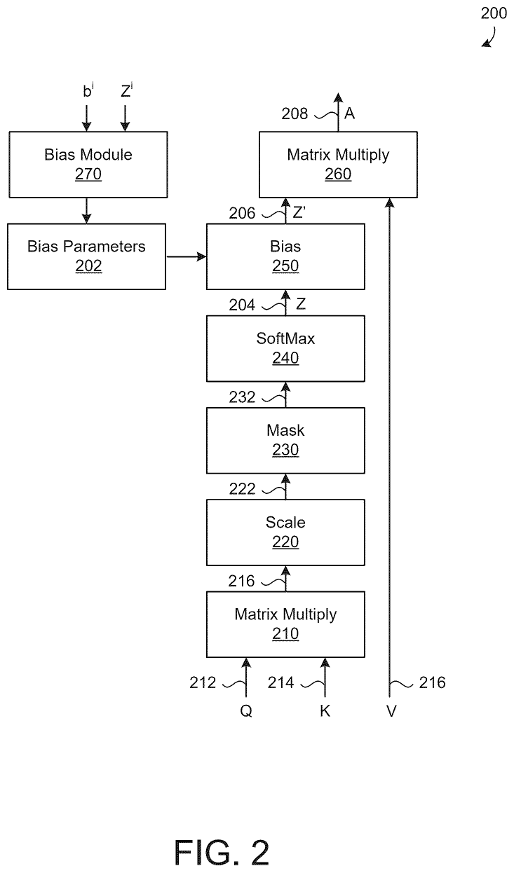

The LM 150 includes a plurality of transformer layers 154, 154a-n, which each include a corresponding biased attention layer 200, 200a-n. In lieu of transformer layers 154, the LM 150 may include a plurality of other types of multi-head attention layers. The LM 150 may also include additional transformer layers that do not include a biased attention layer, or that do not include an attention layer at all. Here, each particular biased attention layer 200 includes a corresponding set of bias parameters 202 (FIG. 2) that are added to respective attention weights 204 (FIG. 2) computed by the particular biased attention layer 200 during inference for a prompt session (see FIG. 2). In some implementations, the corresponding sets of bias parameters 202 are stored in a memory cache 170 in communication with the data processing hardware 12, 72. In some examples, the memory cache 170 is stored on the memory hardware 14, 74. In some examples, the bias parameters 202 are stored separately from the frozen parameters of the LM 150. A biased attention layer 200 may be, for example, a scaled dot-product biased attention layer or a multi-head biased attention layer.

In some examples, during a first prompt session between the user 104 and the LM 150, each corresponding biased attention layer 200 of the plurality of biased attention layers 200 of the LM 150: computes, based on a first prompt 162, a corresponding set of attention weights 204 for the corresponding biased attention layer 200; computes, based on the corresponding set of attention weights 204, bias parameters 202 for biasing a subsequent computation of corresponding set of attention weights 204 during a second prompt session, and stores the computed bias parameters 202 in the memory cache 170. The LM 150 then generates a corresponding response 152 to the first prompt 162 based on the corresponding sets of attention weights 204 computed for the plurality of biased attention layers 200.

Then, during the second prompt session between the user 104 and the LM 150, each corresponding biased attention layer 200 of the plurality of biased attention layers 200 computes, based on a second prompt 162, a corresponding set of attention weights 204 for the corresponding biased attention layer 200, and biases, using the bias parameters 202 stored in the memory cache 170 that were computed for the corresponding biased attention layer 200 during the first prompt session, the corresponding set of attention weights 204. The LM 150 then generates a corresponding response 152 to the second prompt 162 based on the biased sets of attention weights 204 computed for the plurality of biased attention layers 200. Here, the set of bias parameters 202 used to bias the corresponding set of attention weights Z 204 during the second prompt session bias the corresponding set of attention weights Z 204 may be computed without computing any gradients.

After generating the corresponding response 152 to the second prompt 162 during the second prompt session, the bias module 270, for at least one corresponding biased attention layer 200 of the plurality biased attention layers 200, updates, using the corresponding set of attention weights Z 204 computed during the second prompt session, the bias parameters 202 stored in the memory cache 170 for biasing a subsequent computation of the corresponding set of attention weights Z 204 during a third prompt session. Here, the bias parameters 202 are stored in the memory cache 170 for biasing the subsequent computation of the corresponding set of attention weights Z 204 during the third prompt session and may be computed without computing any gradients.

In some examples, the corresponding response 152 to the second prompt 162 is generated during the second prompt session without integrating, as conversational history into the second prompt 162, the first prompt 106 and the corresponding response 152 to the first prompt 162 generated during the first prompt session. In some implementations, the bias parameters 202 stored in the memory cache 170 for biasing the subsequent computation of the corresponding set of attention weights Z 204 during the second prompt session are specific to the same user from whom the first prompt and the second prompt were received. In some examples, multiple sets of bias parameters 202 are stored in the memory cache 170. Here, each set of bias parameters 202 may be specific to a different respective user.

In some implementations, the LM 150 includes a pre-trained neural network-based LM that optimizes parameters of the neural network-based LM during training, and the parameters of the neural network-based LM are frozen during prompt sessions that occur during inference. In some examples, the task specified by the first prompt 162 and the other task specified by the second prompt 162 are associated with a capability that the pre-trained neural network-based LM is not trained to perform.

FIG. 2 is a schematic view of an example biased attention layer 200. In the example shown, the biased attention layer 200 is a scaled dot-product biased attention layer. The biased attention layer 200 includes a matrix multiply layer 210, a scale layer 220, an optional mask layer 230, and a SoftMax layer 240, which together compute attention weights Z. 204 based one or more queries packed into a matrix Q 212, and one or more attention keys packed into a matrix K 214. In the example shown, the attention weights Z 204 are computed as:

$$Z = SoftMax ( \frac{{QK}^{T}}{\sqrt{{d}_{k}}} ) \qquad ( 1 )$$

Non-scaled dot-product attention weights Z 204 may alternatively be computed by omitting the scale factor

$$1 / \sqrt{{d}_{k}}$$

### in EQN (1).

The biased attention layer 200 also includes a bias layer 250 for computing biased attention weights Z′ 206 by biasing the computed attention weights Z 204 based on the bias parameters 202. For example, the bias layer 250 may add together corresponding parameters 202 and corresponding attention weights Z 204 to compute the corresponding biased attention weights Z′ 206. In the example shown, the biased attention weights Z′ 206 are computed as:

$${Z}^{′} = SoftMax ( \frac{{QK}^{T}}{\sqrt{{d}_{k}}} ) + b \qquad ( 2 )$$

The biased attention layer 200 further includes a matrix multiply layer 260 that computes biased attention outputs A 208 of the biased attention layer 200. In the example shown, the biased attention outputs A 208 are computed as:

$$A = ( SoftMax ( \frac{{QK}^{T}}{\sqrt{{d}_{k}}} ) + b ) V \qquad ( 3 )$$

where V is a matrix of packed attention key values 216.

In some examples, a biased attention layer 200 includes a biased multi-head biased attention layer formed by combining the biased attention weights Z′ 206 of a plurality of scaled dot-product biased attention layers, where each scaled dot-product biased attention layer is biased as explained above.

In some implementations, a bias module 270 adapts the bias parameters b 202 based on the attention weights Z 204. In some examples, the bias module 270 adapts the bias parameters b 202 using the following mathematical expression:

$${b}^{i + 1} = {b}^{i} + {CZ}^{i} \qquad ( 4 )$$

where bⁱ⁺¹ are the bias parameters 202 to use for a next prompt session, bⁱ are the bias parameters 202 used for a current prompt session, Zⁱ are the attention weights 204 computed for the current prompt session, and C is a constant selected to control a learning rate. Here, the bias module 270 adapts the bias parameters 202 using an exponentially decaying moving average of previous attention weights Z 204. An example constant Cis selected to have a value between zero and one. Here, as the bias module 270 computes the bias parameters 202 using EQN (4), the bias module 270 works to enhance or remember particular attention weights Z 204 such that previously emphasized attention weights Z 204 will tend to be emphasized in future prompt sessions. In the example of EQN (4), the bias module 270 adapts the bias parameters 202 using an exponentially decaying moving average of previous attention weights Z 204.

Additionally or alternatively, the bias module 270 may adapt the bias parameters b 202 based on feedback received from the user 104 for a response 152 to a prompt 106. In particular, continuing with the example above, the bias module 270 may, after the LM 150 generates the corresponding response 152 to the second prompt 162 during the second prompt session, receive binary feedback indicating one of positive feedback or negative feedback from the user 104 for the corresponding response 152. Here, positive feedback indicates that the user 104 is satisfied with the corresponding response 152 to the second prompt 106, and negative feedback indicates that the user 104 is dissatisfied with the corresponding response 152 to the second prompt 106. Then, for at least one corresponding biased attention layer 200, the bias module 270 updates the bias parameters b 202 stored in the memory cache 170 for biasing a subsequent computation of the corresponding set of attention weights Z 204 during a third prompt session. Here, the bias module 270 updates the bias parameters b 202 using the corresponding set of attention weights Z 204 computed for the at least one corresponding biased attention layer 200 during the second prompt session conditioned upon the corresponding response 152 to the second prompt 162, and the binary feedback. In some examples, the bias module 270 updates the bias parameters b 202 stored in the memory cache 170 using the corresponding set of attention weights Z 204 computed for at least one corresponding biased attention layer 200 during the second prompt session conditioned upon the corresponding response 152 to the second prompt 162, and the binary feedback is based on the scaling factor C. Here, the bias module 270 may update the bias parameters b 202 using the following mathematical expressions:

$$If positive feedback : {b}^{i + 1} = {b}^{i} + {CZ}^{i} \qquad ( 5 )$$

$$If negative feedback : {b}^{i + 1} = {b}^{i} - {CZ}^{i} \qquad ( 6 )$$

where bⁱ⁺¹ are the bias parameters 202 to use for a next prompt session, bⁱ are the bias parameters 202 used for a current prompt session, Zⁱ are the attention weights 204 computed for the current prompt session, and C is the constant selected to control a learning rate. Here, the bias module 270 may update the bias parameters b 202 stored in the memory cache 170 for biasing the subsequent computation of the corresponding set of attention weights Z 204 during the third prompt session without computing any gradients.

Alternatively, the bias module 270 may update the bias parameters b 202 only when the largest number t in the attention weights Z 204 exceeds a pre-determined threshold number T. In particular, the bias module 270 may, during the first prompt session and for each corresponding biased attention layer 200, determine that previous bias parameters b 202 for the corresponding biased attention layer 200 are stored in the memory cache 170. Here, the previous bias parameters b 202 were computed for the corresponding biased attention layer 200 during a prior prompt session that precedes the first prompt session. The bias module 270 then computes the bias parameters b 202 for the corresponding biased attention layer 200 during the first prompt session by, when the largest number t in the set of attention weights Z 204 satisfies the predefined threshold number T (e.g., t is greater than or equal to T), computing, using the corresponding set of attention weights Z 204, the bias parameters b 202 stored in the memory cache 170 for biasing the subsequent computation of the corresponding set of attention weights Z 204 during the second prompt session. When the largest number t in the set of attention weights Z 204 dissatisfies the predefined threshold number T (e.g., t is less than T), the previous bias parameters b 202 stored in the memory cache 170 are used for biasing the subsequent computation of the corresponding set of attention weights Z 204 during the second prompt session. Here, the bias module 270 may compute the bias parameters b 202 using the following mathematical expressions:

$$t = max ( {Z}^{i} ) \qquad ( 7 )$$

$$If t \geq T , {b}^{i + 1} = {b}^{i} + C {Z}^{i} \qquad ( 8 )$$

$$else , {b}^{i + 1} = {b}^{i} \qquad ( 9 )$$

where bⁱ⁺¹ are the bias parameters 202 to use for a next prompt session, bⁱ are the bias parameters 202 used for a current prompt session, Zⁱ are the attention weights 204 computed for the current prompt session, and C is the constant selected to control a learning rate.

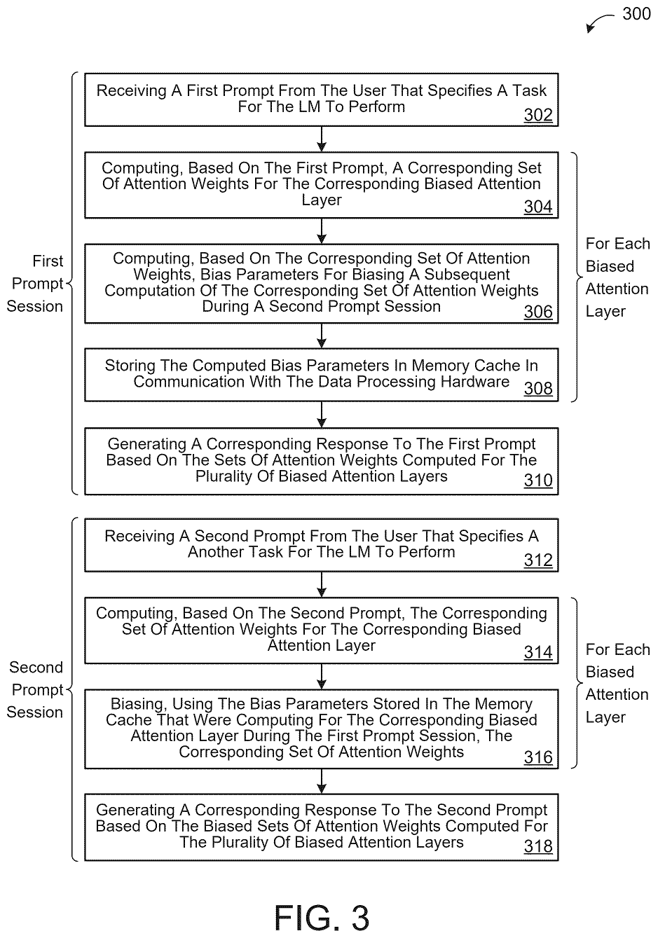

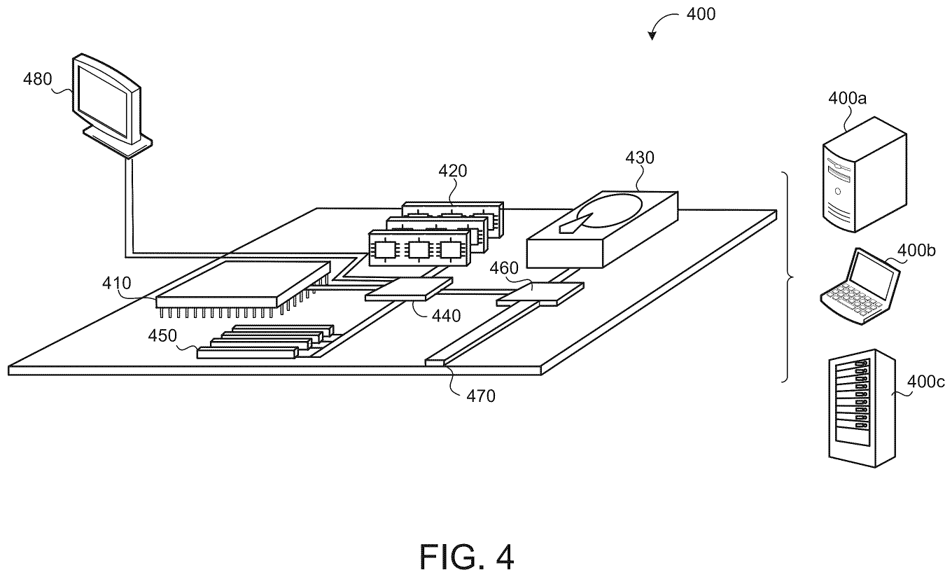

FIG. 3 is a flowchart of an exemplary arrangement of operations for a computer-implemented method 300 of biasing an attention layer 200 of an LM 150. The operations may be performed by data processing hardware 410 (FIG. 4) (e.g., the data processing hardware 12 of the user device 10 or the data processing hardware 72 of the remote computing system 70) based on executing instructions stored on memory hardware 420 (e.g., the memory hardware 14 of the user device 10 or the memory hardware 74 of the remote computing system 70).

During a first prompt session between the user 104 and the LM 150, the method 300 includes at operation 302 receiving a first prompt 162 from the user 104 that specifies a task for the LM 150 to perform. For each corresponding biased attention layer 200 of the plurality of biased attention layers 200 of the LM 150, the method 300 includes, at operation 304 computing, based on the first prompt 162, a corresponding set of attention weights 204 for the corresponding biased attention layer 200, at operation 306 computing, based on the corresponding set of attention weights 204, bias parameters 202 for biasing a subsequent computation of corresponding set of attention weights 204 during a second prompt session, and at operation 308, storing the bias parameters 202 in the memory cache 170. At operation 310, the method 300 includes generating a corresponding response 152 to the first prompt 162 based on the corresponding sets of attention weights 204 computed for the plurality of biased attention layers 200.

At operation 312, during a second prompt session between the user 104 and the LM 150, the method 300 includes receiving a second prompt 162 from the user 104 that specifies another task for the LM 150 to perform. For each corresponding biased attention layer 200 of the plurality of biased attention layers 200, the method 300 includes, at operation 314, computing, based on the second prompt 162, a corresponding set of attention weights 204 for the corresponding biased attention layer 200, and at operation 316, biasing, using the bias parameters 202 stored in the memory cache 170 that were computed for the corresponding biased attention layer 200 during the first prompt session, the corresponding set of attention weights 204. At operation 318, the method 300 includes generating a corresponding response 152 to the second prompt 162 based on the biased sets of attention weights 204 computed for the plurality of biased attention layers 200.

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (i.e., data processing hardware) that can be used to implement the data processing hardware 12 and/or 72, memory 420 (i.e., memory hardware) that can be used to implement the memory hardware 14 and/or 74 or the memory cache 170, a storage device 430 (i.e., memory hardware) that can be used to implement the memory hardware 14 and/or 74 or the memory cache 170, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 490. The low-speed expansion port 490, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A software application (i.e., a software resource) may refer to computer software that causes a computing device to perform a task. In some examples, a software application may be referred to as an “application.” an “app.” or a “program.” Example applications include, but are not limited to, system diagnostic applications, system management applications, system maintenance applications, word processing applications, spreadsheet applications, messaging applications, media streaming applications, social networking applications, and gaming applications.

These computer programs (also known as programs, software, software applications, or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
during a first prompt session between a user and a language model (LM):
receiving a first prompt from the user that specifies a task for the LM to perform;
for each corresponding biased attention layer of a plurality of biased attention layers of the LM:
computing, based on the first prompt, a corresponding set of attention weights for the corresponding biased attention layer;
computing, based on the corresponding set of attention weights, bias parameters for biasing a subsequent computation of the corresponding set of attention weights during a second prompt session; and
storing the computed bias parameters in memory cache in communication with the data processing hardware; and
generating a corresponding response to the first prompt based on the sets of attention weights computed for the plurality of biased attention layers; and
during the second prompt session between the user and the LM:
receiving a second prompt from the user that specifies another task for the LM to perform;
for each corresponding biased attention layer of the plurality of biased attention layers:
computing, based on the second prompt, the corresponding set of attention weights for the corresponding biased attention layer; and
biasing, using the bias parameters stored in the memory cache that were computed for the corresponding biased attention layer during the first prompt session, the corresponding set of attention weights; and
generating a corresponding response to the second prompt based on the biased sets of attention weights computed for the plurality of biased attention layers.

2. The computer-implemented method of claim 1, wherein the operations further comprise, after generating the corresponding response to the second prompt during the second prompt session:
receiving binary feedback indicating one of positive feedback or negative feedback from the user, the positive feedback indicating the user is satisfied with the corresponding response to the second prompt and the negative feedback indicating the user is dissatisfied with the corresponding response to the second prompt; and
for at least one corresponding biased attention layer of the plurality of biased attention layers, updating, using the corresponding set of attention weights computed for the at least one corresponding biased attention layer during the second prompt session conditioned upon the corresponding response to the second prompt and the binary feedback, the bias parameters stored in the memory cache for biasing a subsequent computation of the corresponding set of attention weights during a third prompt session.

3. The computer-implemented method of claim 2, wherein the bias parameters stored in the memory cache for biasing the subsequent computation of the corresponding set of attention weights during the third prompt session are computed without computing any gradients.

4. The computer-implemented method of claim 2, wherein updating the bias parameters stored in the memory cache using the corresponding set of attention weights computed for the at least one corresponding biased attention layers during the second prompt session is conditioned upon the corresponding response to the second prompt, and the binary feedback is further based on a scaling factor.

5. The computer-implemented method of claim 1, wherein the operations further comprise, after generating the corresponding response to the second prompt during the second prompt session, for at least one corresponding biased attention layer of the plurality biased attention layers, updating, using the corresponding set of attention weights computed for the at least one corresponding biased attention layer during the second prompt session, the bias parameters stored in the memory cache for biasing a subsequent computation of the corresponding set of attention weights during a third prompt session.

6. The computer-implemented method of claim 5, wherein updating the bias parameters stored in the memory cache using the corresponding set of attention weights computed for the at least one corresponding biased attention layer during the second prompt session is further based on a scaling factor.

7. The computer-implemented method of claim 1, wherein the operations further comprise, during the first prompt session, for each corresponding biased attention layer:
determining that previous bias parameters for the corresponding biased attention layer are stored in the memory cache, the previous bias parameters computed for the corresponding biased attention layer during a prior prompt session that precedes the first prompt session; and
determining a largest number in the set of attention weights computed for the corresponding biased attention layer,
wherein computing the bias parameters for the corresponding biased attention layer during the first prompt session comprises:
when the largest number in the set of attention weights satisfies a predefined threshold number, updating, using the corresponding set of attention weights, the bias parameters stored in the memory cache for biasing the subsequent computation of the corresponding set of attention weights during the second prompt session; or
when the largest number in the set of attention weights dissatisfies the predefined threshold number, using the previous bias parameters stored in the memory cache for biasing the subsequent computation of the corresponding set of attention weights during the second prompt session.

8. The computer-implemented method of claim 1, wherein the set of bias parameters used to bias the corresponding set of attention weights during the second prompt session represent an exponential decaying moving average of the set of attention weights previously computed for the corresponding biased attention layer during the first prompt session.

9. The computer-implemented method of claim 1, wherein the set of bias parameters used to bias the corresponding set of attention weights during the second prompt session bias the corresponding set of attention weights are computed without computing a gradient.

10. The computer-implemented method of claim 1, wherein the corresponding response to the second prompt is generated during the second prompt session without integrating, as conversational history into the second prompt, the first prompt and the corresponding response to the first prompt generated during the first prompt session.

11. The computer-implemented method of claim 1, wherein the bias parameters stored in the memory cache for biasing the subsequent computation of the corresponding set of attention weights during the second prompt session are specific to the same user from whom the first prompt and the second prompt were received from.

12. The computer-implemented method of claim 11, wherein multiple sets of bias parameters are stored in the memory cache, each set of bias parameters specific to a different respective user.

13. The computer-implemented method of claim 1, wherein the LM comprises a pre-trained neural network-based LM that optimizes parameters of the neural network-based LM during training, the parameters of the neural network-based LM are frozen during the first and second prompt sessions during inference.

14. The computer-implemented method of claim 13, wherein the task specified by the first prompt and the other task specified by the second prompt are associated with a capability that the pre-trained neural network-based LM is not trained to perform.

15. A system comprising:
data processing hardware; and
memory hardware in communication with the data processing hardware, the memory hardware storing instructions that, when executed on the data processing hardware, cause the data processing hardware to perform operations comprising:
during a first prompt session between a user and a language model (LM):
receiving a first prompt from the user that specifies a task for the LM to perform;
for each corresponding biased attention layer of a plurality of biased attention layers of the LM:
computing, based on the first prompt, a corresponding set of attention weights for the corresponding biased attention layer;
computing, based on the corresponding set of attention weights, bias parameters for biasing a subsequent computation of the corresponding set of attention weights during a second prompt session; and
storing the computed bias parameters in memory cache in communication with the data processing hardware; and
generating a corresponding response to the first prompt based on the sets of attention weights computed for the plurality of biased attention layers; and
during the second prompt session between the user and the LM:
receiving a second prompt from the user that specifies another task for the LM to perform;
for each corresponding biased attention layer of the plurality of biased attention layers:
computing, based on the second prompt, the corresponding set of attention weights for the corresponding biased attention layer; and
biasing, using the bias parameters stored in the memory cache that were computed for the corresponding biased attention layer during the first prompt session, the corresponding set of attention weights; and
generating a corresponding response to the second prompt based on the biased sets of attention weights computed for the plurality of biased attention layers.

16. The system of claim 15, wherein the operations further comprise, after generating the corresponding response to the second prompt during the second prompt session:
receiving binary feedback indicating one of positive feedback or negative feedback from the user, the positive feedback indicating the user is satisfied with the corresponding response to the second prompt and the negative feedback indicating the user is dissatisfied with the corresponding response to the second prompt; and
for at least one corresponding biased attention layer of the plurality of biased attention layers, updating, using the corresponding set of attention weights computed for the at least one corresponding biased attention layer during the second prompt session conditioned upon the corresponding response to the second prompt and the binary feedback, the bias parameters stored in the memory cache for biasing a subsequent computation of the corresponding set of attention weights during a third prompt session.

17. The system of claim 16, wherein the bias parameters stored in the memory cache for biasing the subsequent computation of the corresponding set of attention weights during the third prompt session are computed without computing any gradients.

18. The system of claim 16, wherein updating the bias parameters stored in the memory cache using the corresponding set of attention weights computed for the at least one corresponding biased attention layers during the second prompt session is conditioned upon the corresponding response to the second prompt, and the binary feedback is further based on a scaling factor.

19. The system of claim 15, wherein the operations further comprise, after generating the corresponding response to the second prompt during the second prompt session, for at least one corresponding biased attention layer of the plurality biased attention layers, updating, using the corresponding set of attention weights computed for the at least one corresponding biased attention layer during the second prompt session, the bias parameters stored in the memory cache for biasing a subsequent computation of the corresponding set of attention weights during a third prompt session.

20. The system of claim 19, wherein updating the bias parameters stored in the memory cache using the corresponding set of attention weights computed for the at least one corresponding biased attention layer during the second prompt session is further based on a scaling factor.

21. The system of claim 15, wherein the operations further comprise, during the first prompt session, for each corresponding biased attention layer:
determining that previous bias parameters for the corresponding biased attention layer are stored in the memory cache, the previous bias parameters computed for the corresponding biased attention layer during a prior prompt session that precedes the first prompt session; and
determining a largest number in the set of attention weights computed for the corresponding biased attention layer,
wherein computing the bias parameters for the corresponding biased attention layer during the first prompt session comprises:
when the largest number in the set of attention weights satisfies a predefined threshold number, updating, using the corresponding set of attention weights, the bias parameters stored in the memory cache for biasing the subsequent computation of the corresponding set of attention weights during the second prompt session; or
when the largest number in the set of attention weights dissatisfies the predefined threshold number, using the previous bias parameters stored in the memory cache for biasing the subsequent computation of the corresponding set of attention weights during the second prompt session.

22. The system of claim 15, wherein the set of bias parameters used to bias the corresponding set of attention weights during the second prompt session represent an exponential decaying moving average of the set of attention weights previously computed for the corresponding biased attention layer during the first prompt session.

23. The system of claim 15, wherein the set of bias parameters used to bias the corresponding set of attention weights during the second prompt session bias the corresponding set of attention weights are computed without computing a gradient.

24. The system of claim 15, wherein the corresponding response to the second prompt is generated during the second prompt session without integrating, as conversational history into the second prompt, the first prompt and the corresponding response to the first prompt generated during the first prompt session.

25. The system of claim 15, wherein the bias parameters stored in the memory cache for biasing the subsequent computation of the corresponding set of attention weights during the second prompt session are specific to the same user from whom the first prompt and the second prompt were received from.

26. The system of claim 25, wherein multiple sets of bias parameters are stored in the memory cache, each set of bias parameters specific to a different respective user.

27. The system of claim 15, wherein the LM comprises a pre-trained neural network-based LM that optimizes parameters of the neural network-based LM during training, the parameters of the neural network-based LM are frozen during the first and second prompt sessions during inference.

28. The system of claim 27, wherein the task specified by the first prompt and the other task specified by the second prompt are associated with a capability that the pre-trained neural network-based LM is not trained to perform.
